(19) United States
(12) Patent Application Publication
(10) Pub. No.: US 2012/0229019 A1
(43) Pub. Date: Sep. 13, 2012

(54) PHOSPHORS, AND LIGHT EMITTING DEVICE EMPLOYING THE SAME

(75) Inventors: Wei-Ren Liu, Taoyuan City (TW); Yi-Chen Chiu, Hsinchu City (TW); Yao-Tsung Yeh, Taoyuan City (TW); Shyue-Ming Jang, Hsinchu City (TW)

(73) Assignee: INDUSTRIAL TECHNOLOGY RESEARCH INSTITUTE, Hsinchu County (TW)

(21) Appl. No.: 13/083,392

(22) Filed: Apr. 8, 2011

(30) Foreign Application Priority Data
Mar. 7, 2011 (TW) 100107539

(51) Int. Cl. H01J 1/63; C09K 11/77; C09K 11/61; H01J 1/62

(52) U.S. Cl. 313/504; 313/483; 252/301.4 H; 252/301.6 R

(57) ABSTRACT

The disclosure provides a phosphor composed of (Sr_{1-x-y}REₓM_{y})₄Si_{w}Al_{14-w}O_{25-z-w}X_{2z}N_{2w/3}, wherein: M is Ba, Mg, Ca, La, or combinations thereof, RE is Y, Pr, Nd, Eu, Gd, Tb, Ce, Dy, Yb, Er, Sc, Mn, Zn, Cu, Ni, Lu, or combinations thereof, 0.001≦x≦0.6, 0≦y≦0.6, 0≦z≦0.6, 0≦w≦0.6, and 1−x−y>0. The phosphor of the disclosure has a large excitation bandwidth (140-470 nm). Under excitation, the phosphor of the invention emits visible light and may be collocated with other phosphors to provide a white light illumination device.

### CROSS REFERENCE TO RELATED APPLICATIONS

This application is based upon and claims the benefit of priority from the prior Taiwai Patent Application No. 100107539, filed on Mar. 7, 2011, the entire contents of which are incorporated herein by reference.

### BACKGROUND

1. Technical Field

The present invention relates to a phosphor, and in particular relates to an aluminate phosphor and a light emitting device employing the same.

2. Description of the Related Art

The light emitting diode has advantages described as follows: (1) its small size is suitable for illumination in an array package and collocating with different colors if necessary; (2) a relatively long life of more than 10,000 hours and 50 times that of the conventional tungsten lamp; (3) durability due to transparent resin applied as packaging resin, thereby enhancing shock resistance; (4) its interior structure is free of mercury, such that the LED is environmentally friendly and does not have problems such as pollution and waste management; (5) saves energy and consumes low electric power, wherein the electric power consumption of the LED is ⅓ to ⅕ that of the conventional tungsten lamp.

A commercially available light emitting device including a light emitting diode in combination with phosphors has been provided and has gradually replaced conventional tungsten lamps and fluorescent lamps. The phosphor employed by the light emitting device is a critical factor in determining luminescence efficiency, color rendering, color temperatures, and lifespan of the light emitting device.

In general, the excitation light source of conventional phosphors is a short wavelength ultraviolet light (UV) such as 147 nm, 172 nm, 185 nm, or 254 nm. The phosphors excited by the short wavelength UV have high light absorption and light transfer efficiency. Compared with phosphors excited by short wavelength ultraviolet light, phosphors excited by long wavelength ultraviolet light and visible light (350-470 nm) are rare. Further, phosphors excited optionally by short wavelength ultraviolet light, long wavelength ultraviolet light, and visible light (350-470 nm) are extremely rare.

The disclosure provides aluminate phosphors with a significantly large excitation bandwidth (140-470 nm), and thus the aluminate phosphors can be excited by various excitation light sources (such as a short wavelength ultraviolet light source, long wavelength ultraviolet light source, and visible light (blue light) source). Further, the light emitting device employing the aluminate phosphors of the disclosure can be further combined with other light sources or other suitable phosphors to form a white light illumination device.

### SUMMARY

The disclosure provides an aluminate phosphor composed of (Sr_{1-x-y}REₓM_{y})₄Si_{w}Al_{14-w}O_{25-z-w}X_{2z}N_{2w/3}, wherein: M is Ba, Mg, Ca, La, or combinations thereof; RE is Y, Pr, Nd, Eu, Gd, Tb, Ce, Dy, Yb, Er, Sc, Mn, Zn, Cu, Ca, La, or combinations thereof; X is F, Cl, Br, or combinations thereof; 0.001≦x≦0.6; 0≦y≦0.6; 0≦z≦0.6; and 0≦x≦0.6.

The disclosure also provides a light emitting device, including an excitation light source and the aforementioned aluminate phosphor

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a cross section of a light emitting device of an embodiment of the disclosure.

FIG. 2 is a cross section of a light emitting device according to another embodiment of the disclosure.

FIG. 3 shows photoluminescence spectrum of the phosphor as disclosed in Example 1.

FIG. 4 shows the emission intensities of the phosphors as disclosed in Examples 1-7.

FIG. 5 shows the X-ray pattern of the phosphor as disclosed in Example 14.

FIG. 6 shows excitation and photoluminescence spectra of the phosphor as disclosed in Example 14.

FIG. 7 shows photoluminescence spectra of the phosphors as disclosed in Examples 5, 22, 23, and 24.

FIG. 8 shows photoluminescence spectra of the phosphors as disclosed in Examples 14, 25, 26, 27, and 28.

FIG. 9 shows photoluminescence spectra of the phosphors as disclosed in Examples 5, 14, 29, and commercially available phosphor (Zn2SiO4:Mn²⁺).

FIG. 10 shows photoluminescence spectra of the phosphor as disclosed in Example 14, and commercially available phosphors (BOS-507 and YAG-432).

FIG. 11 shows photoluminescence spectra of the light emitting devices as disclosed in t Examples 31, 32, and 33.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides an aluminate phosphor composed of (Sr_{1-x-y}REₓM_{y})₄Si_{w}Al_{14-w}O_{25-z-w}X_{2z}N_{2w/3}, wherein: M is Ba, Mg, Ca, La, or combinations thereof; RE is Y, Pr, Nd, Eu, Gd, Tb, Ce, Dy, Yb, Er, Sc, Mn, Zn, Cu, Ca, La, or combinations thereof; X is F, Cl, Br, or combinations thereof; 0.001≦x≦0.6; 0≦y≦0.6; 0≦z≦0.6; 0≦w≦0.6; and 1−x−y>0.

In an embodiment of the disclosure, W can be 0 and RE can be Eu. Therefore, the aluminate phosphor can be (Sr_{1-x-y}EuₓM_{y})₄Al₁₄O_{25-z}X_{2z}. Since X can be F, Cl, or Br, and the aluminate phosphor can be (Sr_{1-x-y}EuₓM_{y})₄Al₁₄O_{25-z}F_{2z}, (Sr_{1-x-y}EuₓM_{y})₄Al₁₄O_{25-z}C_{l2z}, or (Sr_{1-x-y}EuₓM_{y})₄Al₁₄O_{25-z}Br_{2z}, wherein 0.001≦x≦0.6, 0.001≦y≦0.6, and 0≦z≦0.6. Further, since X can be at least one of F, Cl, and Br, the aluminate phosphor can be (Sr_{1-x-y}EuₓM_{y})₄Al₁₄O_{25-z}(Cl₁₋ᵥBrᵥ)_{2z}, (Sr_{1-x-y}EuₓM_{y})₄Al₁₄O_{25-z}(Cl₁₋ᵥFᵥ)_{2z} or (Sr_{1-x-y}EuₓM_{y})₄Al₁₄O_{25-z(Br}₁₋ᵥFᵥ)_{2z}, wherein 0.001≦x≦0.6, 0.001≦y≦0.6, 0.001≦z≦0.6, and 0.001≦v≦0.999.

In an embodiment of the disclosure, y and w can be 0 simultaneously, and RE can be Eu. Therefore, the aluminate phosphor can be (Sr₁₋ₓEuₓ)₄Al₁₄O_{25-z}X_{2z}. Since X can be F, Cl, or Br, the aluminate phosphor can be (Sr₁₋ₓEuₓ)₄Al₁₄O_{25-z}F_{2z}, (Sr₁₋ₓEuₓ)₄Al₁₄O_{25-z}Cl_{2z}, or (Sr₁₋ₓEuₓ)₄Al₁₄O_{25-z}Br_{2z}, wherein 0.001≦x≦0.6, and 0.001≦z≦0.6. Further, since X can be at least one of F, Cl, and Br, the aluminate phosphor can be (Sr₁₋ₓEuₓ)₄Al ₁₄O_{25-z}(Cl₁₋ᵥBrᵥ)_{2z}, (Sr₁₋ₓEuₓ)₄Al₁₄O_{25-z}(Cl₁₋ᵥFᵥ)_{2z}, or (Sr₁₋ₓEuₓ)₄Al₁₄O_{25-z}(Br₁₋ᵥFᵥ)_{2z}, wherein 0.001≦x≦0.6, 0≦z≦0.6, and 0.001≦v≦0.999.

In an embodiment of the disclosure, since y and z can be 0 simultaneously, and RE can be Eu, the phosphor can be (Sr₁₋ₓEuₓ)₄Si_{w}Al_{14-w}O_{25-w}N_{2w/3}, wherein 0.001≦x≦0.6, and 0.001≦w≦0.6.

According to some embodiments of the disclosure, x can be within the following ranges: 0.001≦x≦0.1, 0.1≦x≦0.2, 0.2≦x≦0.3, 0.3≦x≦0.4, 0.4≦x≦0.5, or 0.5≦x≦0.6. When y is not equal to 0, y can be within the following ranges: 0.001≦y≦0.1, 0.1≦y≦0.2, 0.2≦y≦0.3, 0.3≦y≦0.4, 04 0.5, or 0.5≦y≦0.6. Further, when z is not equal to 0, w can be within the following ranges: 0.001≦z≦0.1, 0.1≦z≦0.2, 0.2≦z≦0.3, 0.3≦z≦0.4, 0.4≦z≦0.5, or 0.5≦z≦0.6. Further, when w is not equal to 0, w can be within the following ranges: 0.001≦w≦0.1, 0.1≦w≦0.2, 0.2≦w≦0.3, 0.3≦w≦0.4, 0.4≦w≦0.5, or 0.5≦w≦0.6. The aluminate phosphor of the disclosure is excited by a light with a wavelength of between 140-470 nm to emit a light having a major emission peak of between 480-500 nm and a CIE coordination of (0.14, 0.35).

The method for fabricating the aluminate phosphor of the disclosure includes the following steps:

Mixing a mixture which includes the following components: (1) strontium-containing oxide; (2) aluminium oxide; and (3) RE-containing oxide; and sintering the mixture under a reductive atmosphere. Further, the mixture further includes at least one of: (4) M-containing oxide; (5) strontium-containing halide, and (6) Si₃N₄. The step of sintering the mixture can have a sintering temperature of between 1300-1500° C. (such as 1400° C.), and the mixture can be sintered at the sintering temperature for 0.5-32 hrs (such as 8 hr).

In an embodiment of the disclosure, the: (1) strontium-containing oxide can be strontium oxide, or strontium carbonate, or combinations thereof; (3) RE-containing oxide can be oxide containing Y, Pr, Nd, Eu, Gd, Tb, Ce, Dy, Yb, Er, Sc, Mn, Zn, Cu, Ni, or Lu, or combinations of the previous mentioned metal oxides; (4) M-containing oxide can be oxide containing Ba, Mg, Ca, or La, or combinations of the previous mentioned metal oxides. Further, the reductive atmosphere includes hydrogen gas and a carrier gas such inert gas.

According to embodiments of the disclosure, a light emitting device is also provided, including an excitation light source and the aforementioned phosphor. The excitation light source can include a light emitting diode (LED), a laser diode (LD), an organic light emitting diode (OLED), cold cathode fluorescent lamp (CCFL), external electrode fluorescent lamp (EEFL), or vacuum ultra violet (VUV), or Hg vapor arc.

Since the aluminate phosphor of the disclosure emits a blue-green light, the light emitting device can further include a red phosphor, a yellow phosphor, or a blue phosphor. The red phosphor includes (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺, (Ca,Sr,Ba)₂Si₅N₈:Eu²⁺, (Ca,Sr)AlSiN₃:Eu²⁺, Sr₃SiO5:Eu²⁺, Ba₃MgSi₂O₈:Eu²⁺, Mn²⁺, or ZnCdS:AgCl. The yellow phosphor includes Y3Al5O12:Ce³⁺ (YAG), Tb₃Al₅O₁₂:Ce³⁺ (TAG), (Ca,Mg,Y)SiwAlₓO_{y}N_{z}:Eu²⁺, or (Mg,Ca,Sr,Ba)₂SiO₄:Eu²⁺. The blue phosphor includes BaMgAl₁₀O₁₇:Eu²⁺ (BAM), (Ca,Sr,Ba)₅(PO₄)₃Cl:Eu²⁺ (SCA), ZnS:Ag⁺, or (Ca,Sr,Ba)₅SiO₄(F,Cl,Br)₆:Eu²⁺.

The light emitting device can serve as a pilot device (such as traffic sign, and a pilot lamb of an instrument), back light source (such as a back light of an instrument and a display), light fitting (such as bias light, traffic sign, or signboard), or germicidal lamp.

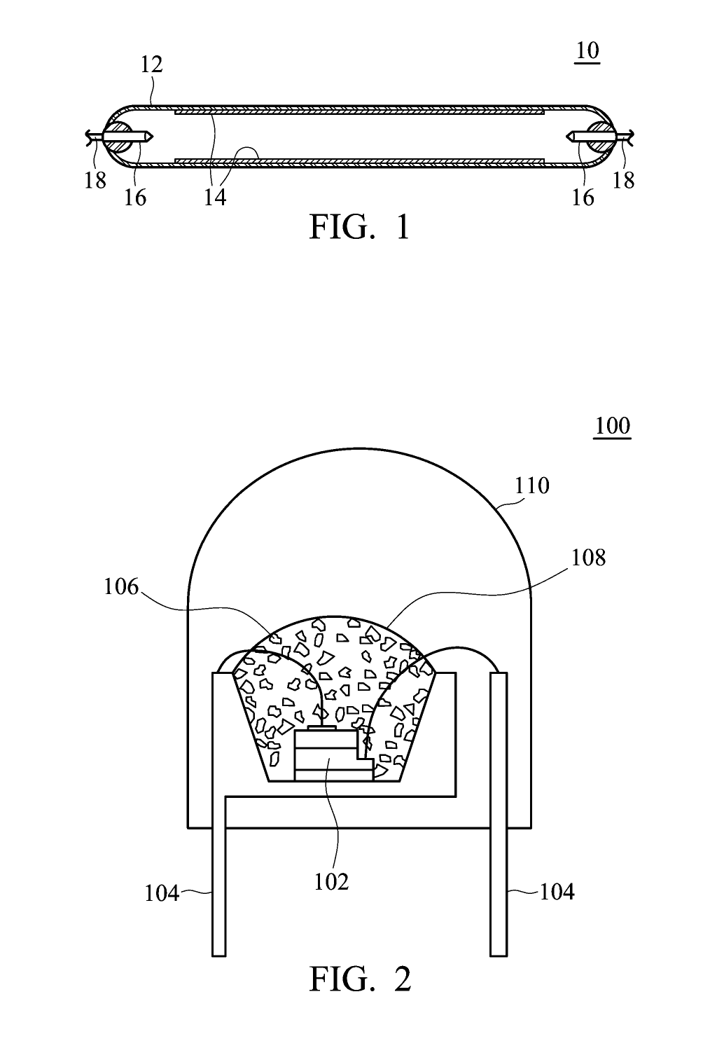

According to an embodiment of the invention, referring to FIG. 1, the light emitting device 10 has a lamp tube 12, a phosphor disposed on the inside walls of the lamp tube 12, an excitation light source 16, and electrodes 18 disposed on each of the two ends of the lamp tube 12. Further, the lamp tube 12 of the light emitting device 10 can further include Hg and an inert gas. The phosphor 14 can include the phosphor of the invention. Moreover, the phosphor 14 can further include a yellow phosphor, or a combination of a red phosphor and a green phosphor for generating white-light radiation. The light emitting device 10 can serve as a back light source of a liquid crystal display.

According to another embodiment of the invention, referring to FIG. 2, the light emitting device 100 employs a light emitting diode or laser diode 102 as an excitation light source, and the light emitting diode or laser diode 102 is disposed on a lead frame 104. A transparent resin 108 mixed with a phosphor 106 is coated on and covers the light emitting diode or laser diode 102. A sealing material 110 is used to encapsulate the light emitting diode or laser diode 102, the lead frame 104, and the transparent resin 108 together. The phosphor 106 can include the phosphor of the disclosure or can further include a red phosphor, a yellow phosphor, and a blue phosphor.

The following examples are intended to illustrate the invention more fully without limiting their scope, since numerous modifications and variations will be apparent to those skilled in this art.

### EXAMPLE 1

39.6 mmol of SrCO₃ (5.848 g, FW=147.63, sold and manufactured by ALDRICH), 0.4 mmol of Eu₂O₃ (0.14 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.99}Eu_{0.01})₄Al₁₄O₂₅ was prepared.

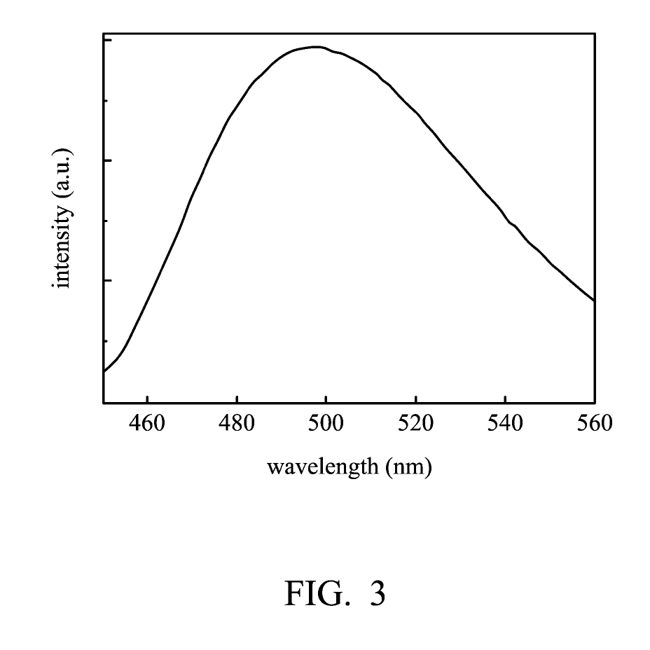

Next, the emission wavelength, and emission intensity of the (Sr_{0.99}Eu_{0.01})₄Al₁₄O₂₅ were measured (the relative emission intensity of (Sr_{0.99}Eu_{0.01})₄Al₁₄O₂₅ was set as 100) and are shown in Table 1. FIG. 3 shows the photoluminescence spectrum of (Sr_{0.99}Eu_{0.01})₄Al₁₄O₂₅ (excited by 351 nm light), and the major peak of the emission band of (Sr_{0.99}Eu_{0.01})₄Al₁₄O₂₅ was 490 nm.

### EXAMPLE 2

39.2 mmol of SrCO₃ (5.789 g, FW=147.63, sold and manufactured by ALDRICH), 0.8 mmol of Eu₂O₃ (0.14 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.98}Eu_{0.02})₄Al ₁₄O₂₅ was prepared.

Next, the emission wavelength, and relative emission intensity of the (Sr_{0.98}Eu_{0.02})₄Al₁₄O₂₅ were measured (in comparison with Example 1) and are shown in Table 1.

### EXAMPLE 3

38.4 mmol of SrCO₃ (5.67 g, FW=147.63, sold and manufactured by ALDRICH), 1.6 mmol of Eu₂O₃ (0.56 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.96}Eu_{0.04})₄Al₁₄O₂₅ was prepared.

Next, the emission wavelength, and relative emission intensity of the (Sr_{0.96}Eu_{0.04})₄Al₁₄O₂₅ were measured (in comparison with Example 1) and are shown in Table 1.

### EXAMPLE 4

37.6 mmol of SrCO₃ (5.551 g, FW=147.63, sold and manufactured by ALDRICH), 2.4 mmol of Eu₂O₃ (0.84 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.94}Eu_{0.06})₄Al ₁₄O₂₅ was prepared.

Next, the emission wavelength, and relative emission intensity of the (Sr_{0.94}Eu_{0.06})₄Al₁₄O₂₅ were measured (in comparison with Example 1) and are shown in Table 1.

### EXAMPLE 5

36.8 mmol of SrCO₃ (5.432 g, FW=147.63, sold and manufactured by ALDRICH), 3.2 mmol of Eu₂O₃ (1.12 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})_{4A114025} was prepared.

Next, the emission wavelength, and relative emission intensity of the (Sr_{0.92}Eu_{0.08})₄Al₁₄O₂₅ were measured (in comparison with Example 1) and are shown in Table 1.

### EXAMPLE 6

36.0 mmol of SrCO₃ (5.313 g, FW=147.63, sold and manufactured by ALDRICH), 4.0 mmol of Eu₂O₃ (1.4 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.90}Eu_{0.10})₄Al₁₄O₂₅ was prepared.

Next, the emission wavelength, and relative emission intensity of the (Sr_{0.90}Eu_{0.10})₄Al₁₄O₂₅ were measured (in comparison with Example 1) and are shown in Table 1.

### EXAMPLE 7

35.2 mmol of SrCO₃ (5.194 g, FW=147.63, sold and manufactured by ALDRICH), 4.8 mmol of Eu₂O₃ (1.68 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.88}Eu_{0.12})₄Al₁₄O₂₅ was prepared.

Next, the emission wavelength, and relative emission intensity of the (Sr_{0.88}Eu_{0.12})₄Al₁₄O₂₅ were measured (in comparison with Example 1) and are shown in Table 1.

TABLE 1

| | relative emission |
|---|---|
| | intensity |
| Example 1 | 100 |
| Example 2 | 106 |
| Example 3 | 113 |
| Example 4 | 115 |
| Example 5 | 116 |
| Example 6 | 111 |
| Example 7 | 105 |

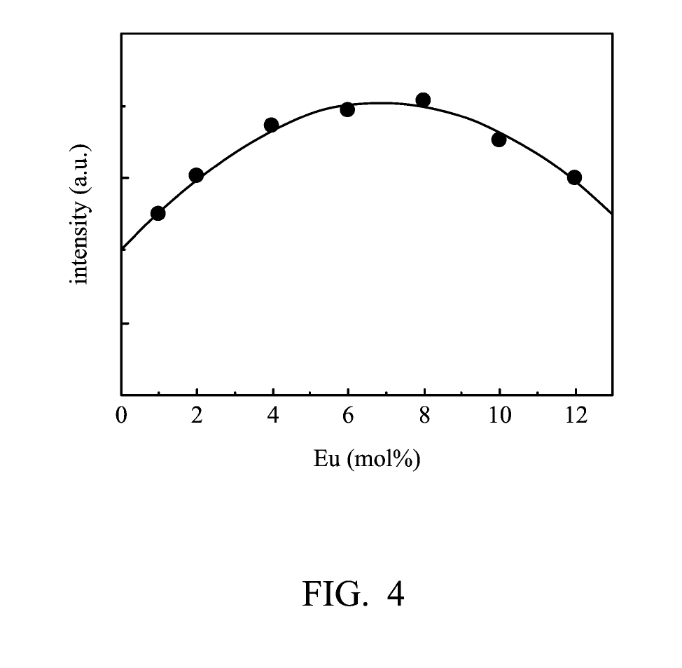

The phosphors disclosed in Examples 1-7 had various Sr/Eu ratios. The aluminate phosphor with the Sr/Eu ratio of 0.92:0.08 exhibited a relatively high emission intensity, and is shown in FIG. 4.

### EXAMPLE 8

36.3 mmol of SrCO₃ (5.35 g, FW=147.63, sold and manufactured by ALDRICH), 3.2 mmol of Eu₂O₃ (1.12 g, FW=351.917, sold and manufactured by ALDRICH), 0.5 mmol of SrF2 (0.062 g, FW=125.63, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.95}F_{0.1} was prepared.

Next, the emission wavelength, and relative emission intensity of the (Sr_{0.92}Eu_{0.08})₄Al₁₄O_{24.95}F_{0.1} were measured (in comparison with Example 5) and are shown in Table 2.

### EXAMPLE 9

35.3 mmol of SrCO₃ (5.21 g, FW=147.63, sold and manufactured by ALDRICH), 3.2 mmol of Eu₂O₃ (1.12 g, FW=351.917, sold and manufactured by ALDRICH), 1.5 mmol of SrF2 (0.186 g, FW=125.63, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.85}F_{0.3} was prepared.

Next, the emission wavelength, and relative emission intensity of the (Sr_{0.92}Eu_{0.08})₄Al₁₄O_{24.85}F_{0.3} were measured (in comparison with Example 5) and are shown in Table 2.

### EXAMPLE 10

34.8 mmol of SrCO₃ (5.21 g, FW=147.63, sold and manufactured by ALDRICH), 3.2 mmol of Eu₂O₃ (1.12 g, FW=351.917, sold and manufactured by ALDRICH), 2.0 mmol of SrF₂ (0.248 g, FW=125.63, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.8}F_{0.4} was prepared.

Next, the emission wavelength, and relative emission intensity of the (Sr_{0.92}Eu_{0.08})₄Al₁₄O_{24.8}F_{0.4} were measured (in comparison with Example 5) and are shown in Table 2.

### EXAMPLE 11

33.8 mmol of SrCO₃ (5.21 g, FW=147.63, sold and manufactured by ALDRICH), 3.2 mmol of Eu₂O₃ (1.12 g, FW=351.917, sold and manufactured by ALDRICH), 3.0 mmol of SrF₂ (0.372 g, FW=125.63, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.7}F_{0.6} was prepared.

Next, the emission wavelength, and relative emission intensity of the (Sr_{0.92}Eu_{0.08})₄Al₁₄O_{24.7}F_{0.6} were measured (in comparison with Example 5) and are shown in Table 2.

TABLE 2

| | relative emission |
|---|---|
| | intensity |
| Example 5 | 100 |
| Example 8 | 101 |
| Example 9 | 105 |
| Example 10 | 103 |
| Example 11 | 105 |

The phosphors disclosed in Examples 8-11 had various F atom doping amounts and the same Sr/Eu ratios. The introduced F doping amount caused the relative emission intensity to increase.

### EXAMPLE 12

36.3 mmol of SrCO₃ (5.35 g, FW=147.63, sold and manufactured by ALDRICH), 3.2 mmol of Eu₂O₃ (1.12 g, FW=351.917, sold and manufactured by ALDRICH), 0.5 mmol of SrCl₂ (0.079 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.95}Cl_{0.1} was prepared.

Next, the emission wavelength, and relative emission intensity of the (Sr_{0.92}Eu_{0.08})₄Al₁₄O_{24.95}Cl_{0.1} were measured (in comparison with Example 5) and are shown in Table 3.

### EXAMPLE 13

35.8 mmol of SrCO₃ (5.28 g, FW=147.63, sold and manufactured by ALDRICH), 3.2 mmol of Eu₂O₃ (1.12 g, FW=351.917, sold and manufactured by ALDRICH), 1.0 mmol of SrCl₂ (0.158 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.9}Cl_{0.2} was prepared.

Next, the emission wavelength, and relative emission intensity of the (Sr_{0.92}Eu_{0.08})₄Al₁₄O_{24.9}Cl_{0.2} were measured (in comparison with Example 5) and are shown in Table 3.

### EXAMPLE 14

35.3 mmol of SrCO₃ (5.21 g, FW=147.63, sold and manufactured by ALDRICH), 3.2 mmol of Eu₂O₃ (1.12 g, FW=351.917, sold and manufactured by ALDRICH), 1.5 mmol of SrCl₂ (0.237 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.85}Cl_{0.3} was prepared.

Next, the emission wavelength, and relative emission intensity of the (Sr_{0.92}Eu_{0.08})₄Al₁₄O_{24.85}Cl_{0.3} were measured (in comparison with Example 5) and are shown in Table 3.

### EXAMPLE 15

34.8 mmol of SrCO₃ (5.14 g, FW=147.63, sold and manufactured by ALDRICH), 3.2 mmol of Eu₂O₃ (1.12 g, FW=351.917, sold and manufactured by ALDRICH), 2.0 mmol of SrCl₂ (0.316 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.8}Cl_{0.4} was prepared.

Next, the emission wavelength, and relative emission intensity of the (Sr_{0.92}Eu_{0.08})₄Al₁₄O_{24.8}Cl_{0.4} were measured (in comparison with Example 5) and are shown in Table 3.

### EXAMPLE 16

33.8 mmol of SrCO₃ (5.00 g, FW=147.63, sold and manufactured by ALDRICH), 3.2 mmol of Eu₂O₃ (1.12 g, FW=351.917, sold and manufactured by ALDRICH), 3.0 mmol of SrCl₂ (0.474 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.7}Cl_{0.6} was prepared.

Next, the emission wavelength, and relative emission intensity of the (Sr_{0.92}Eu_{0.08})₄Al₁₄O_{24.7}Cl_{0.6} were measured (in comparison with Example 5) and are shown in Table 3.

TABLE 3

| | relative emission |
|---|---|
| | intensity |
| Example 5 | 100 |
| Example 12 | 105 |
| Example 13 | 104 |
| Example 14 | 113 |
| Example 15 | 103 |
| Example 16 | 103 |

The phosphors disclosed in Examples 12-16 had various Cl atom doping amounts and the same Sr/Eu ratios. The introduced Cl doping amount caused the relative emission intensity to increase.

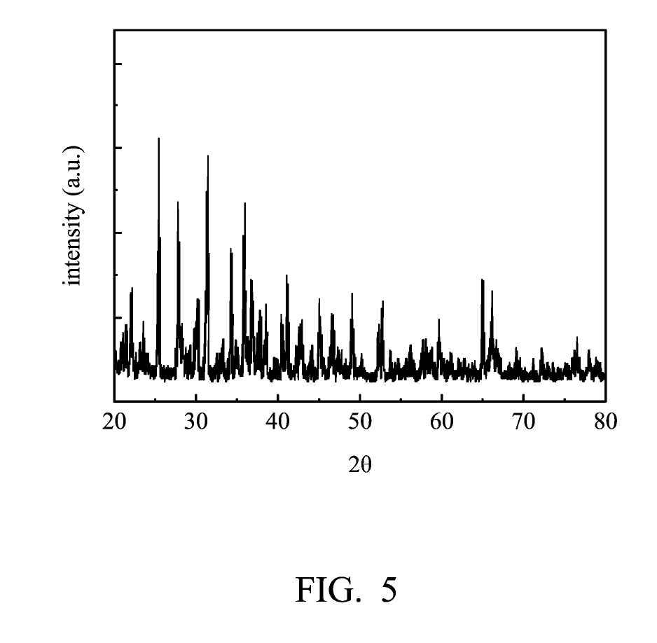

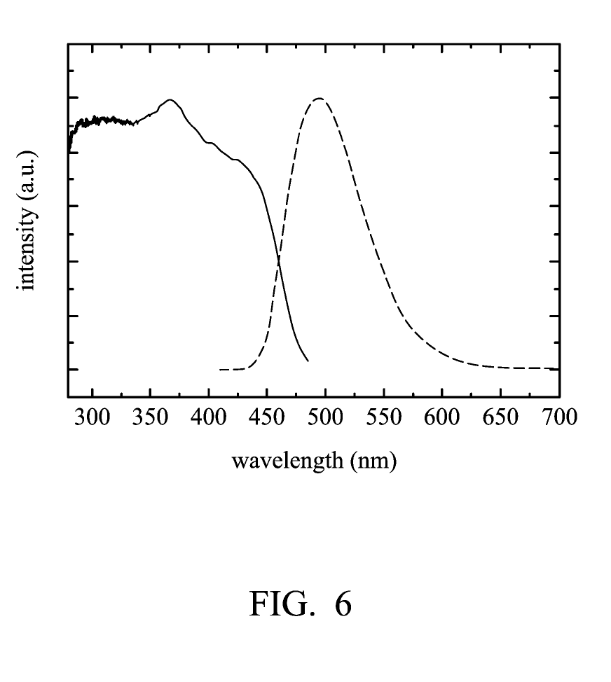

The phosphor with an Eu²⁺ doping amount of 5mol % exhibited the optimal emission strength, which was about 1.21 times larger than that of the phosphor disclosed in Example 1. The phosphors with the structure of (Sr_{0.92}Eu_{0.08})₄Al₁₄O_{24.85}Cl_{0.3} exhibited a relatively high emission intensity. The X-ray diffraction pattern of (Sr_{0.92}Eu_{0.08})₄Al₁₄O_{24.85}Cl_{0.3} is shown in FIG. 5 and the excitation and photoluminescence spectra of (Sr_{0.92}Eu_{0.08})₄Al₁₄O_{24.85}Cl_{0.3} are shown in FIG. 6. The phosphor had wide excitation band, and the major peak of the emission band was 490 nm.

### EXAMPLE 17

36.3 mmol of SrCO₃ (5.35 g, FW=147.63, sold and manufactured by ALDRICH), 3.2 mmol of Eu₂O₃ (1.12 g, FW=351.917, sold and manufactured by ALDRICH), 0.5 mmol of SrBr₂ (0.123 g, FW=247.44, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.95}Br_{0.1} was prepared.

Next, the emission wavelength, and relative emission intensity of the (Sr_{0.92}Eu_{0.08})₄Al₁₄O_{24.95}Br_{0.1} were measured (in comparison with Example 5) and are shown in Table 4.

### EXAMPLE 18

35.8 mmol of SrCO₃ (5.28 g, FW=147.63, sold and manufactured by ALDRICH), 3.2 mmol of Eu₂O₃ (1.12 g, FW=351.917, sold and manufactured by ALDRICH), 1.0 mmol of SrBr₂ (0.246 g, FW=247.44, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.9}Br_{0.2}was prepared.

Next, the emission wavelength, and relative emission intensity of the (Sr_{0.92}Eu_{0.08})₄Al₁₄O_{24.9}Br_{0.2} were measured (in comparison with Example 5) and are shown in Table 4.

### EXAMPLE 19

35.3 mmol of SrCO₃ (5.21 g, FW=147.63, sold and manufactured by ALDRICH), 3.2 mmol of Eu₂O₃ (1.12 g, FW=351.917, sold and manufactured by ALDRICH), 1.5 mmol of SrBr₂ (0.369 g, FW=247.44, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.85}Br_{0.3} was prepared.

Next, the emission wavelength, and relative emission intensity of the (Sr_{0.92}Eu_{0.08})₄Al₁₄O_{24.85}Br_{0.3} were measured (in comparison with Example 5) and are shown in Table 4.

### EXAMPLE 20

34.8 mmol of SrCO₃ (5.14 g, FW=147.63, sold and manufactured by ALDRICH), 3.2 mmol of Eu₂O₃ (1.12 g, FW=351.917, sold and manufactured by ALDRICH), 2.0 mmol of SrBr₂ (0.492 g, FW=247.44, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.8}Br_{0.4} was prepared.

Next, the emission wavelength, and relative emission intensity of the (Sr_{0.92}Eu_{0.08})₄Al₁₄O_{24.8}Br_{0.4} were measured (in comparison with Example 5) and are shown in Table 4.

### EXAMPLE 21

34.3 mmol of SrCO₃ (5.07 g, FW=147.63, sold and manufactured by ALDRICH), 3.2 mmol of Eu₂O₃ (1.12 g, FW=351.917, sold and manufactured by ALDRICH), 3.0 mmol of SrBr₂ (0.615 g, FW=247.44, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Al₁₄O_{24.75}Br_{0.5} was prepared.

Next, the emission wavelength, and relative emission intensity of the (Sr_{0.92}Eu_{0.08})₄Al₁₄O_{24.75}Br_{0.5} were measured (in comparison with Example 5) and are shown in Table 4.

TABLE 4

| | relative emission |
|---|---|
| | intensity |
| Example 5 | 100 |
| Example 17 | 99 |
| Example 18 | 91 |
| Example 19 | 48 |
| Example 20 | 52 |
| Example 21 | 43 |

The phosphors disclosed in Examples 17-21 had various Br atom doping amounts and the same Sr/Eu ratios.

### EXAMPLE 22

36.8 mmol of SrCO₃ SrCO₃ (5.432 g, FW=147.63, sold and manufactured by ALDRICH), 3.2 mmol of Eu₂O₃ (1.12 g, FW=351.917, sold and manufactured by ALDRICH), 2 mmol of Si₃N₄ (0.28 g, FW=140.29, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Si_{0.2}Al_{13.8}O_{24.87}N_{0.13} was prepared.

Next, the emission wavelength, and relative emission intensity of the (Sr_{0.92}Eu_{0.08})₄Si_{0.2}Al_{13.8}O_{24.87}N_{0.13} were measured (in comparison with Example 5) and are shown in Table 5.

### EXAMPLE 23

36.8 mmol of SrCO₃ (5.432 g, FW=147.63, sold and manufactured by ALDRICH), 3.2 mmol of Eu₂O₃ (1.12 g, FW=351.917, sold and manufactured by ALDRICH), 5 mmol of Si₃N₄ (0.70 g, FW=140.29, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Si_{0.5}Al_{13.5}O_{24.67}N_{0.33} was prepared.

Next, the emission wavelength, and relative emission intensity of the (Sr_{0.92}Eu_{0.08})₄Si_{0.5}Al_{13.5}O_{24.67}N_{0.33} were measured (in comparison with Example 5) and are shown in Table 5.

### EXAMPLE 24

36.8 mmol of SrCO₃ (5.432 g, FW=147.63, sold and manufactured by ALDRICH), 3.2 mmol of Eu₂O₃ (1.12 g, FW=351.917, sold and manufactured by ALDRICH), 7 mmol of Si₃N₄ (0.981 g, FW=140.29, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Sr_{0.92}Eu_{0.08})₄Si_{0.7}Al_{13.3}O_{24.53}N_{0.47} was prepared.

Next, the emission wavelength, and relative emission intensity of the (Sr_{0.92}Eu_{0.08})₄Si_{0.7}Al_{13.3}O_{24.53}N_{0.47} were measured (in comparison with Example 5) and are shown in Table 5.

TABLE 5

| | relative emission |
|---|---|
| | intensity |
| Example 5 | 100 |
| Example 22 | 81 |
| Example 23 | 70 |
| Example 24 | 33 |

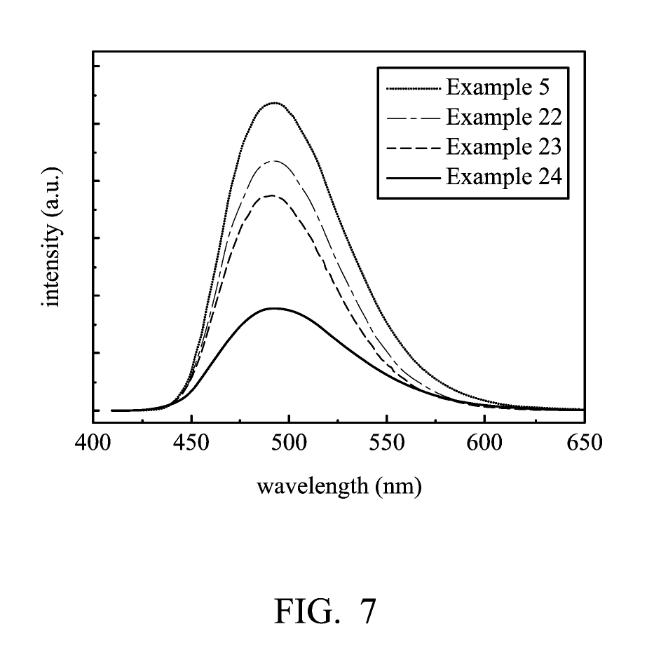

The phosphors disclosed in Examples 22-24 had various Si/N ratio. FIG. 7 shows the photoluminescence spectra of aluminate phosphors disclosed in Examples 22-24 (excited by 365 nm light).

### EXAMPLE 25

10 mmol of CaCO₃ (1.001 g, FW=100.09, sold and manufactured by ALDRICH), 25.3 mmol of SrCO₃ (3.735 g, FW=147.63, sold and manufactured by ALDRICH), 3.2 mmol of Eu₂O₃ (1.12 g, FW=351.917, sold and manufactured by ALDRICH), 1.5 mmol of SrCl₂ (0.237 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Ca_{0.25}Sr_{0.67}Eu_{0.08})₄Al₁₄O_{24.85}Cl_{0.3} was prepared.

Next, the emission wavelength, and relative emission intensity of the (Ca_{0.25}Sr_{0.67}Eu_{0.08})₄Al₁₄O_{24.85}Cl_{0.3} were measured (in comparison with Example 5) and are shown in Table 6.

### EXAMPLE 26

20 mmol of CaCO₃ (1.001 g, FW=100.09, sold and manufactured by ALDRICH), 15.3 mmol of SrCO₃ (2.258 g, FW=147.63, sold and manufactured by ALDRICH), 3.2 mmol of Eu₂O₃ (1.12 g, FW=351.917, sold and manufactured by ALDRICH), 1.5 mmol of SrCl₂ (0.237 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Ca_{0.5}Sr_{0.42}Eu_{0.08})₄Al₁₄O_{24.85}Cl_{0.3} was prepared.

Next, the emission wavelength, and relative emission intensity of the (Ca_{0.5}Sr_{0.42}Eu_{0.08})₄Al₁₄O_{24.85}Cl_{0.3} were measured (in comparison with Example 5) and are shown in Table 6.

### EXAMPLE 27

10 mmol BaCO₃ (1.973 g, FW=197.35, sold and manufactured by ALDRICH), 25.3 mmol of SrCO₃ (3.735 g, FW=147.63, sold and manufactured by ALDRICH), 3.2 mmol of Eu₂O₃ (1.12 g, FW=351.917, sold and manufactured by ALDRICH), 1.5 mmol of SrCl₂ (0.237 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Ba_{0.25}Sr_{0.67}Eu_{0.08})₄Al₁₄O_{24.85}Cl_{0.3} was prepared.

Next, the emission wavelength, and relative emission intensity of the (Ba_{0.25}Sr_{0.67}Eu_{0.08})₄Al₁₄O_{24.85}Cl_{0.3} were measured (in comparison with Example 5) and are shown in Table 6.

### EXAMPLE 28

20 mmol BaCO₃ (3.946 g, FW=197.35, sold and manufactured by ALDRICH), 15.3 mmol of SrCO₃(2.258 g, FW=147.63, sold and manufactured by ALDRICH), 3.2 mmol of Eu₂O₃ (1.12 g, FW=351.917, sold and manufactured by ALDRICH), 1.5 mmol of SrCl₂ (0.237 g, FW=158.53, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (Ba_{0.5}Sr_{0.42}Eu_{0.08})₄Al₁₄O_{24.85}Cl_{0.3} was prepared.

Next, the emission wavelength, and relative emission intensity of the (Ba_{0.5}Sr_{0.42}Eu_{0.08})₄Al₁₄O_{24.85}Cl_{0.3} were measured (in comparison with Example 5) and are shown in Table 6.

TABLE 6

| | relative emission |
|---|---|
| | intensity |
| Example 5 | 100 |
| Example 25 | 73 |
| Example 26 | 38 |
| Example 27 | 39 |
| Example 28 | 7 |

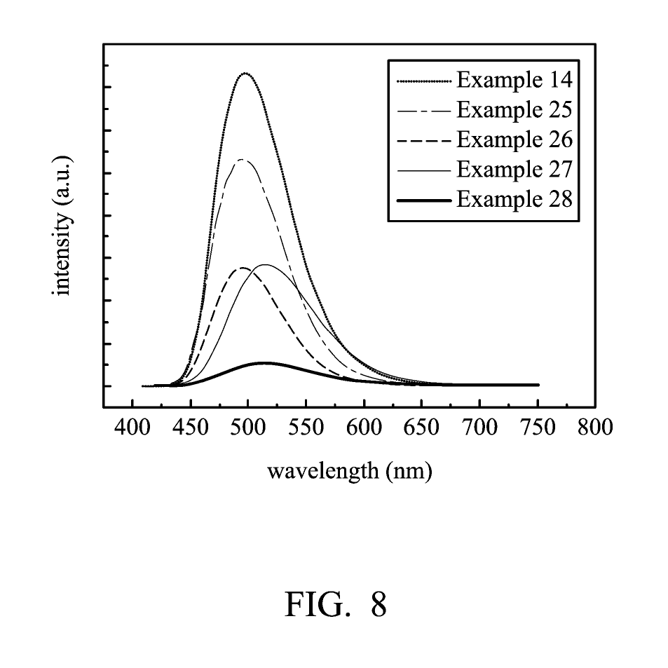

The phosphors disclosed in Examples 25-28 had various Ba/Sr/Eu or Ca/Sr/Eu ratios. FIG. 8 shows the photoluminescence spectra of aluminate phosphors disclosed in Examples 25-28 (excited by 365 nm light).

### EXAMPLE 29

0.1 mmol La₂O₃ (0.325 g, FW=325·84, sold and manufactured by ALDRICH), 36.7 mmol of SrCO₃ (5.418 g, FW=147.63, sold and manufactured by ALDRICH), 3.2 mmol of Eu₂O₃ (1.12 g, FW=351.917, sold and manufactured by ALDRICH), and 140 mmol of Al₂O₃ (14.274 g, FW=101.96, sold and manufactured by STREM) were weighted, evenly mixed and grinded, and charged in an alumina crucible. After sintering at 1400° C. for 8 hours under 15% H₂/85% N₂, and washing, filtering, and heat drying, a pure phase of the phosphor (La_{0.0025}Sr_{0.9175}Eu_{0.08})₄Al₁₄O₂₅ was prepared.

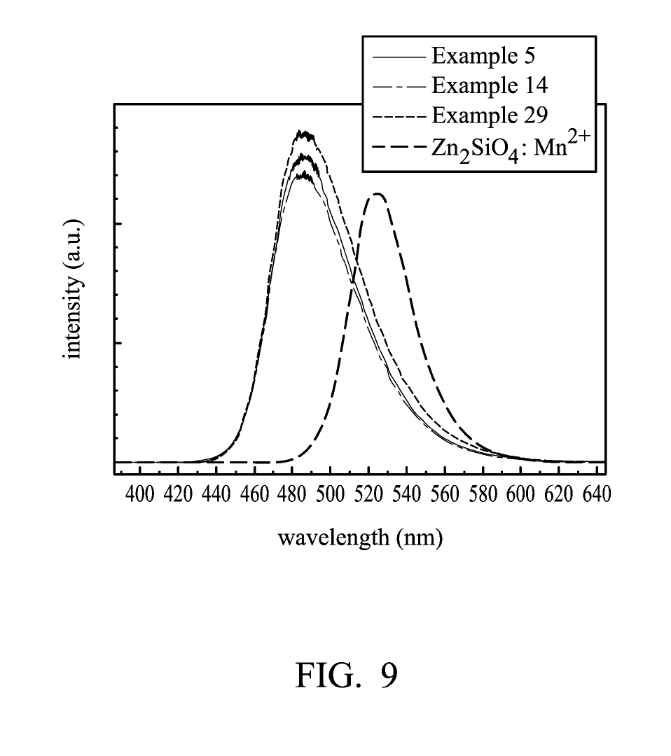

Next, the emission wavelength, and relative emission intensity of the (La_{0.0025}Sr_{0.9175}Eu_{0.08})₄Al₁₄O₂₅ were measured (excited by 365 nm light, and in comparison with conventional phosphor Zn₂SiO₄:Mn²⁺) and are shown in Table 7. FIG. 9 shows the photoluminescence spectrum of aluminate phosphors disclosed in Example 29 (excited by 172 nm light).

TABLE 7

| | relative emission |
|---|---|
| | intensity |
| Zn₂SiO₄:Mn²⁺ | 100 |
| Example 5 | 113 |
| Example 14 | 106 |
| Example 29 | 122 |

### EXAMPLE 30

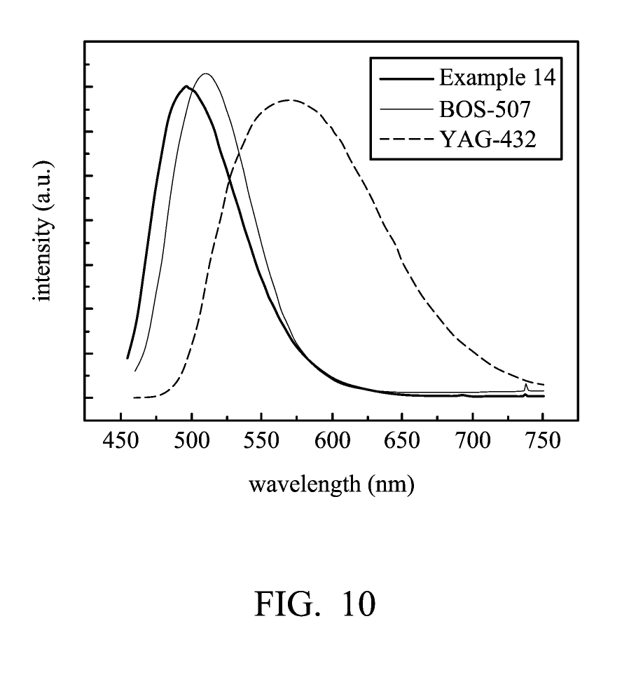

FIG. 10 shows the photoluminescence spectra (excited by 450 nm light) of (Sr_{0.92}Eu_{0.08})₄Al₁₄O_{24.85}Cl_{0.3}, and phosphors currently commercially available (such as Ba₂SiO₄:Eu²⁺(BOS-507), and Y₃Al₅O₁₂:Ce³⁺ (YAG-432)). Further, the absorptivity and quantum efficiency (excited by 400 nm light) of the phosphor (Sr_{0.92}Eu_{0.08})₄Al₁₄O_{24.85}Cl_{0.3} and the phosphors currently commercially available (such as Ba₂SiO₄:Eu²⁺ (BOS-507), and BaMgAl₁₀O₁₇:Eu²⁺, Mn²⁺ (BAMMn)) were measured, and the results are shown in Table 8.

TABLE 8

| | | quantum |
|---|---|---|
| | absorption(%) | efficiency(%) |
| (Sr_{0.92}Eu_{0.08})₄Al₁₄O_{24.85}Cl_{0.3} | 89.7 | 97.8 |
| BOS-507 | 88.4 | 90.0 |
| BAMMn | 46.9 | 91.9 |

### EXAMPLE 31

A blue light emitting diode (having a wavelength of 460 nm), a red light emitting diode (having a wavelength of 630 nm), 1.5 g of yellow phosphor YAG, and 0.05 g of an aluminate phosphor (Sr_{0.92}Eu_{0.08})₄Al₁₄O_{24.85}Cl_{0.3} were arranged to form a white light emitting device. Next, the blue light emitting diode and the red light emitting diode were driven by driving currents of 25 mA and 20 mA respectively, and the correlated color temperature (CCT), color rendering index (CRI), and the C.I.E coordinates of the white light emitting device were measured. The results are shown in Table 9.

### EXAMPLE 32

A blue light emitting diode (having a wavelength of 460 nm), a red light emitting diode (having a wavelength of 630 nm), 1.5 g of yellow phosphor YAG, and 0.05 g of an aluminate phosphor (Sr_{0.92}Eu_{0.08})₄Al₁₄O_{24.85}Cl_{0.3} were arranged to form a white light emitting device. Next, the blue light emitting diode and the red light emitting diode were driven by driving currents of 25 mA and 13 mA respectively, and the correlated color temperature (CCT), color rendering index (CRI), and the C.I.E coordinates of the white light emitting device were measured. The results are shown in Table 9.

### EXAMPLE 33

A blue light emitting diode (having a wavelength of 460 nm), a red light emitting diode (having a wavelength of 630 nm), and 1.5 g of yellow phosphor YAG were arranged to form a white light emitting device. Next, the blue light emitting diode and the red light emitting diode were driven by driving currents of 25 mA and 13 mA respectively, and the correlated color temperature (CCT), color rendering index (CRI), and the C.I.E coordinates of the white light emitting device were measured. The results are shown in Table 9.

TABLE 9

| | Example 31 | Example 32 | Example 33 |
|---|---|---|---|
| Driving current | 20 mA | 13 mA | 13 mA |
| of red light | | | |
| emitting diode | | | |
| phosphors | 1.5 g YAG | 1.5 g YAG | 1.5 g YAG |
| | 0.05 g | 0.05 g | |
| | (Sr_{0.92}Eu_{0.08})₄Al₁₄O_{24.85}Cl_{0.3} | (Sr_{0.92}Eu_{0.08})₄Al₁₄O_{24.85}Cl_{0.3} | |
| C.I.E | (0.417, 0.391) | (0.445, 0.385) | (0.447, 0.403) |
| coordinates | | | |
| CCT (K) | 3264 | 2706 | 2818 |
| CRI | 90.1 | 82.5 | 87.5 |

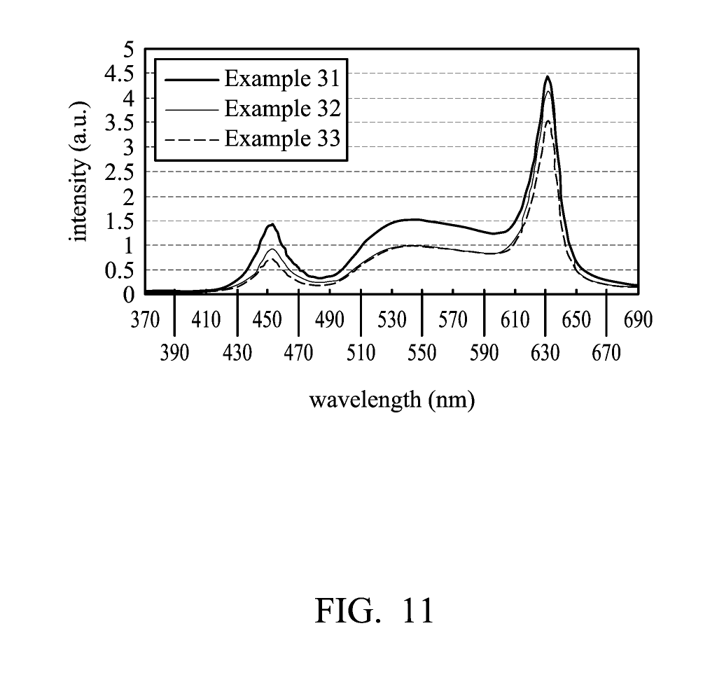

The photoluminescence spectra of the white light emitting devices of Example 31-33 are shown in FIG. 11. As shown in Table 9 and FIG. 11, the phosphors of the disclosure can be applied in a white light LED to enhance the color rendering index thereof.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A phosphor, having a formula:
(Sr_{1-x-y}REₓM_{y})₄Si_{w}Al_{14-w}O_{25-z-w}X_{2z}N_{2w/3}
wherein, M is Ba, Mg, Ca, La, or combinations thereof, RE is Y, Pr, Nd, Eu, Gd, Tb, Ce, Dy, Yb, Er, Sc, Mn, Zn, Cu, Ca, La, or combinations thereof, X is F, Cl, Br, or combinations thereof, 0.001≦x≦0.6, 0≦y≦0.6, 0≦z≦0.6, 0≦w≦0.6, and 1−x−y>0.

2. The phosphor as claimed in claim 1, wherein the phosphor comprises (Sr_{1-x-y}EuₓM_{y})₄Al₁₄O_{25-z}F_{2z}, (Sr_{1-x-y}EuₓM_{y})₄Al₁₄O_{25-z}Cl_{2z}, or (Sr_{1-x-y}EuₓM_{y})₄Al₁₄O_{25-z}Br_{2z}, wherein 0.001≦x≦0.6, 0.001≦y≦0.6, and 0≦z≦0.6.

3. The phosphor as claimed in claim 1, wherein the phosphor comprises (Sr₁₋ₓEuₓ)4Al₁₄O_{25-z}F_{2z}, (Sr₁₋ₓEuₓ)₄Al₁₄O_{25-z}Cl_{2z}, or (Sr₁₋ₓEuₓ)₄Al₁₄O_{25-z}Br_{2z}, wherein 0.001≦x≦0.6, and 0≦z≦0.6.

4. The phosphor as claimed in claim 1, wherein the phosphor comprises (Sr₁₋ₓEuₓ)₄Si_{w}Al_{14-w}O_{25-w}N_{2w/3}, wherein 0.001≦x≦0.6, and 0.001≦w≦0.6.

5. The phosphor as claimed in claim 1, wherein the phosphor is excited by a light with a wavelength of between 140-470 nm to emit a light with a major emission peak of between 480-500 nm.

6. A light emitting device, comprising:
an excitation light source; and
the phosphor as claimed in claim 1.

7. The light emitting device as claimed in claim 6, wherein the excitation light source comprises a light emitting diode (LED), a laser diode (LD), an organic light emitting diode (OLED), cold cathode fluorescent lamp (CCFL), external electrode fluorescent lamp (EEFL), or vacuum ultra violet (VUV), or Hg vapor arc.

8. The light emitting device as claimed in claim 6, wherein the light emitting device is a white light emitting device.

9. The light emitting device as claimed in claim 8, further comprising:
a red phosphor.

10. The light emitting device as claimed in claim 8, wherein the red phosphor comprises (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺, (Ca,Sr,Ba)₂Si₅N₈:Eu²⁺, (Ca,Sr)AlSiN₃:Eu²⁺, Sr₃SiO₅:Eu²⁺, Ba₃MgSi₂O₈:Eu²⁺, Mn²⁺, or ZnCdS:AgCl.

11. The light emitting device as claimed in claim 8, further comprising:
a yellow phosphor.

12. The light emitting device as claimed in claim 8, wherein the yellow phosphor comprises Y₃Al₅O₁₂:Ce³⁺, Tb₃Al₅O₁₂:Ce³⁺, (Ca,Mg,Y)Si_{w}AlₓO_{y}N_{z}:Eu²⁺, or (Mg,Ca,Sr,Ba)₂SiO₄:Eu²⁺.

13. The light emitting device as claimed in claim 8, further comprising:
a blue phosphor.

14. The light emitting device as claimed in claim 8, wherein the blue phosphor comprises BaMgAl₁₀O₁₇:Eu²⁺, (Ca,Sr,Ba)₅(PO₄)₃Cl:Eu²⁺, (Ca,Sr,Ba)₅SiO₄(F,Cl,Br)₆:Eu²⁺, or ZnS:Ag+.
